(19) United States
(12) Patent Application Publication
(10) Pub. No.: US 2011/0138228 A1
(43) Pub. Date: Jun. 9, 2011

(54) VERIFICATION COMPUTER PRODUCT AND APPARATUS

(75) Inventors: Koichiro Takayama, Kawasaki (JP); Rafael Kazumiti Morizawa, Kawasaki (JP)

(73) Assignee: FUJITSU LIMITED, Kawasaki-shi (JP)

(21) Appl. No.: 12/957,970

(22) Filed: Dec. 1, 2010

(30) Foreign Application Priority Data
Dec. 4, 2009 (JP) 2009-276767

(51) Int. Cl. G06F 11/22

(52) U.S. Cl. 714/32; 714/E11.146

(57) ABSTRACT

A non-transitory, computer-readable recording medium stores therein a verification program that causes a computer to execute detecting from a structure expressing a group of scenarios for verifying an operation of a design under verification and by hierarchizing sequences for realizing the operation as nodes, a similar node similar to a faulty node representing a sequence in which a fault has occurred; generating a string of sequences represented by a group of nodes on a path starting from a start node of the structure to the detected similar node; and outputting the generated string of sequences.

### CROSS REFERENCE TO RELATED APPLICATIONS

This application is based upon and claims the benefit of priority of the prior Japanese Patent Application No. 2009-276767, filed on Dec. 4, 2009, the entire contents of which are incorporated herein by reference.

### FIELD

The embodiment discussed herein is related to verification of software or hardware.

### BACKGROUND

In recent years, in system development for software and hardware, the progress of design techniques has lead to the advent of large-scale and complicated systems. A complicated, large-scale system in turn tends to increase the ratio of the verification process to the overall development period. In the verification process, whether a system is operating normally is verified (see, e.g., Japanese Laid-Open Patent Publication Nos. 2004-220356, H11-39179, and 2007-52703).

Specifically, in the verification process, for example, a test pattern is given in the form of a scenario to a system as a design under verification, and the behavior consequent to the test pattern is checked to verify whether the system operates normally. Here, if a fault is detected in a certain sequence, a scenario including a similar sequence identical to or similar to the fault-related sequence must be selected and tested to uncover a fault related to the detected fault.

According to the conventional technique, however, a criterion or a means for deriving a scenario including a similar sequence is not clear. This poses a problem of difficulty in properly selecting a scenario necessary for verifying the occurrence of a related fault. As a result, uncovering of the related fault turns out insufficient, bringing about a problem of a decline in verification quality.

### SUMMARY

According to an aspect of an embodiment, a non-transitory, computer-readable recording medium stores therein a verification program that causes a computer to execute detecting from a structure expressing a group of scenarios for verifying an operation of a design under verification and by hierarchizing sequences for realizing the operation as nodes, a similar node similar to a faulty node representing a sequence in which a fault has occurred; generating a string of sequences represented by a group of nodes on a path starting from a start node of the structure to the detected similar node; and outputting the generated string of sequences.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic of an example of a verification method.

FIG. 2 is an explanatory diagram of an example of the data structure of a group of scenarios (hMSC).

FIG. 3 is an explanatory diagram of an example of the data structure of a node (bMSC).

FIG. 4 is a block diagram of a hardware configuration of a verification apparatus according to an embodiment.

FIG. 5 is a diagram of a functional configuration of the verification apparatus.

FIGS. 6A and 6B are explanatory diagrams of examples of specifying screens.

FIG. 7 is an explanatory diagram of an example of the memory contents of a similar node table.

FIGS. 8A to 8C are explanatory diagrams of examples of detection of a similar node.

FIG. 9 is an explanatory diagram of examples of setting in the similar node table.

FIG. 10 is an explanatory diagram of an example of scenario generating.

FIG. 11 is an explanatory diagram of an example of the memory contents of a scenario DB.

FIG. 12 is an explanatory diagram of an example of a scenario.

FIG. 13 is a flowchart of an example of a verification procedure by the verification apparatus.

FIG. 14 is a flowchart of an example of a similar-node detecting process.

FIG. 15 is a flowchart of an example of the scenario generating process.

### DESCRIPTION OF EMBODIMENTS

Preferred embodiments of the present invention will be explained with reference to the accompanying drawings.

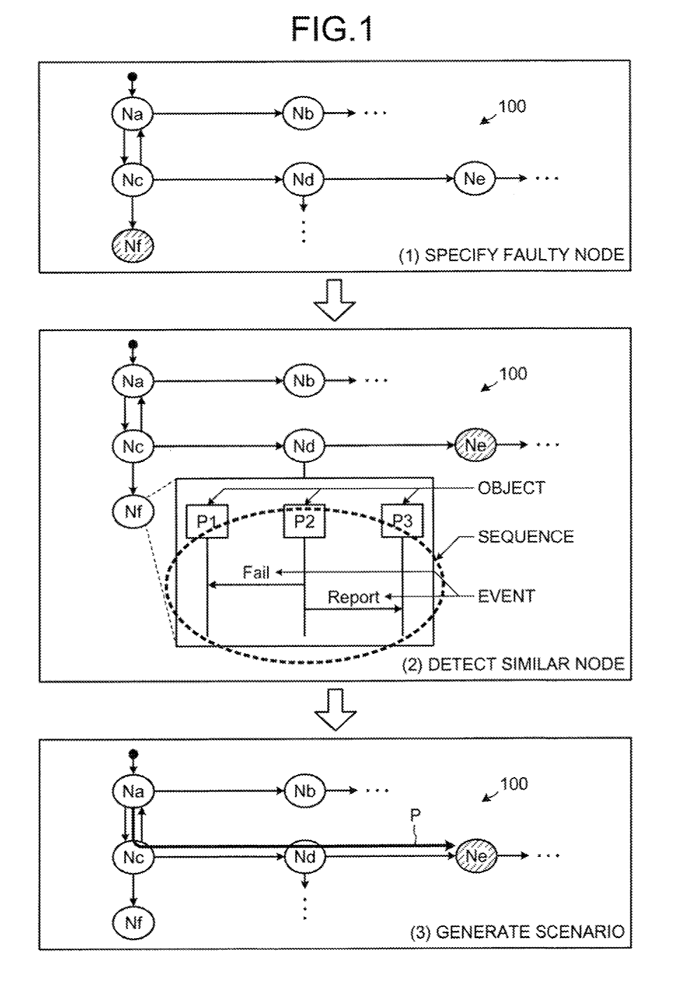

FIG. 1 is a schematic of an example of a verification method. According to this method, a group of scenarios for verifying the operation of software or hardware to be verified as a design under verification are expressed as a structure in which sequences for realizing an operation of the design under verification are hierarchized as nodes.

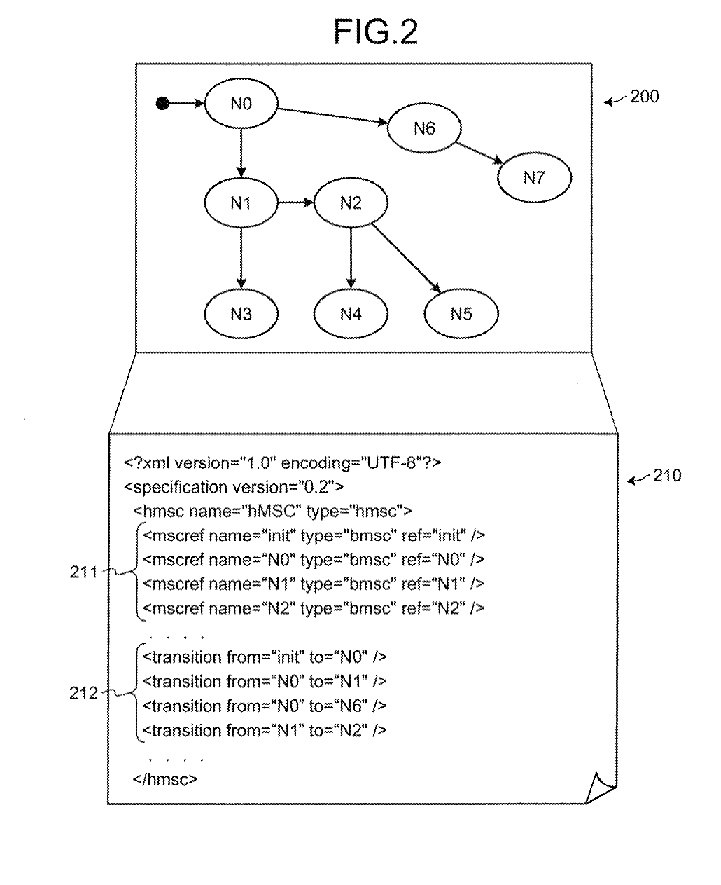

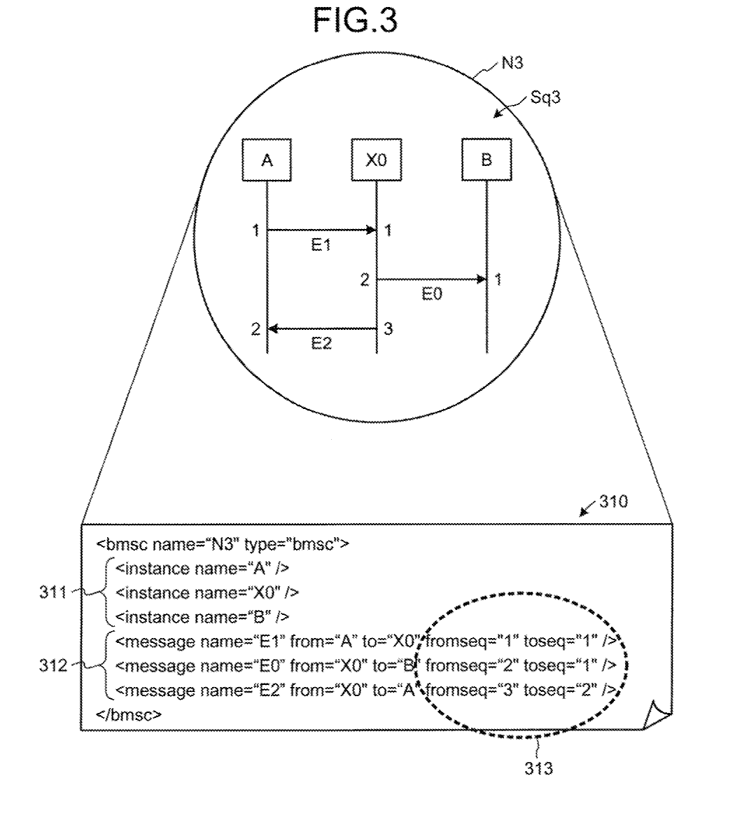

A sequence represents a procedure that expresses events (or messages) transmitted/received between objects (or instances) in a time-sequence. An object (or instance) represents a block included in the design under verification or an external environment interfering with the design under verification. The structure and the sequence will be described in detail later with reference to FIGS. 2 and 3.

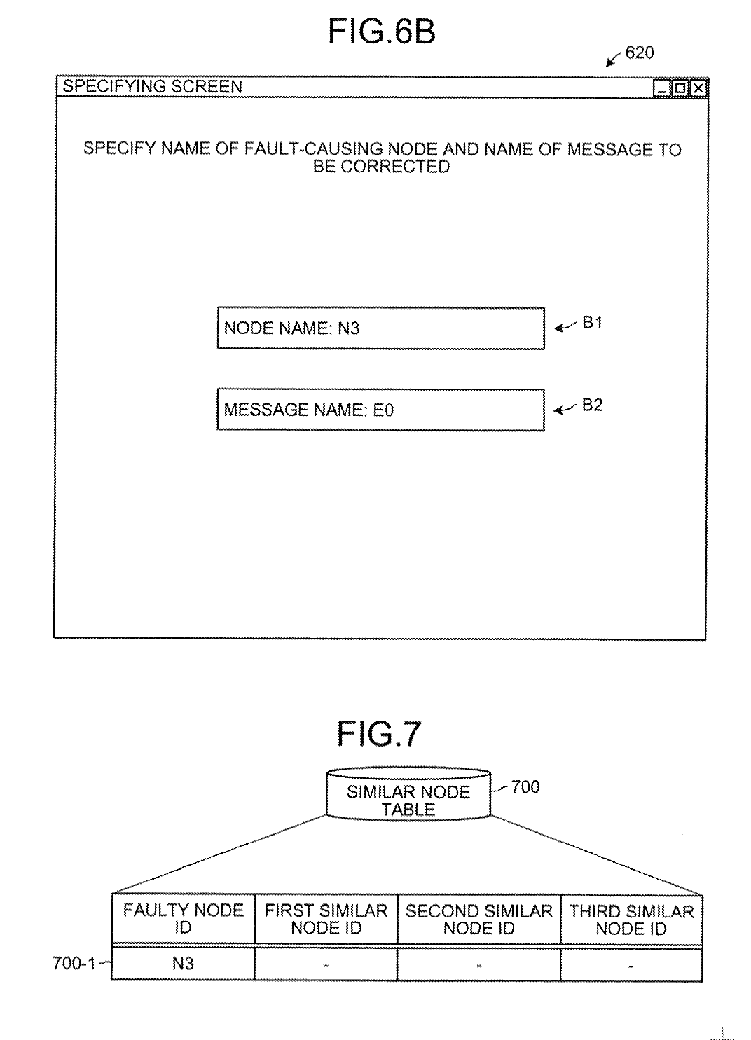

As depicted in FIG. 1, according to the method, a node at which a fault is occurring (hereinafter “faulty node”) is specified in a structure 100 representing a group of scenarios for a design under verification ((1) in FIG. 1). For example, according to the method, on a faulty node specifying screen (see FIG. 6A), a user executes operation input to specify a faulty node Nf from the structure 100.

According to the method, a node similar to the specified faulty node Nf (hereinafter “similar node”) is detected in the structure 100 ((2) in FIG. 1). The similar node is, for example, automatically detected in the structure 100, based on the contents of a sequence represented by the faulty node. In this example, a node Ne is detected as the similar node.

The method is carried out to make a scenario including sequences represented by a group of nodes Na, Nc, Nd, and Ne on a path P starting from a start node Na of the structure 100 to the detected similar node Ne ((3) in FIG. 1). Hence, the scenario is generated as the scenario for executing the sequences represented by the nodes in the order of “node Na→node Nc→node Nd→node Ne”.

This scenario is the scenario for verifying the occurrence of a fault at the similar node Ne, that is, a scenario for uncovering a fault related to the fault occurring at the faulty node Nf. In this manner, the method allows automatic generation of a scenario for verifying the occurrence of another fault related to one fault occurring in a design under verification. This improves the comprehensiveness of verification of the design under verification, thus improves verification quality.

The data structure of a group of scenarios for verifying an operation of a design under verification will be described. A group of scenarios written in a high-level Message Sequence Chart (hMSC) are expressed as an Extensible Markup Language (XML) description. hMSC is a chart having a basic MSC (bMSC) element representing a sequence (diagram), being used as one method of expressing the structure.

FIG. 2 is an explanatory diagram of an example of the data structure of a group of scenarios (hMSC). In FIG. 2, a structure 200 is a directional graph for expressing a group of scenarios for verifying an operation of a design under verification. Specifically, the structure 200 is generated by representing sequences for realizing the operation of the design under verification as nodes N0 to N7 plotted into a directional graph.

The structure 200 is described as hMSC information 210 using XML. In the hMSC information 210, a group of nodes included in the structure 200 (XML description 211) and connection relations between nodes (XML description 212) are defined. A black circle in FIG. 2 represents a starting point (init.). In the structure 200, therefore, a node N0 connected directly to the black circle, i.e., starting point, is a start node.

The data structure of each node representing each sequence that is an element of hMSC will be described by taking a node N3 as an example. FIG. 3 is an explanatory diagram of an example of the data structure of the node (bMSC). In FIG. 3, a sequence Sq3 is a procedure for realizing an operation of the design under verification that is represented by the node N3.

The sequence Sq3 is described as bMSC information 310 using XML. In the bMSC information 310, a group of instances included in the sequence Sq3 (XML description 311) and messages transmitted/received between instances (XML description 312) are defined. The XML description 312 includes a description of the order of messages on the time axes of the instances (reference numeral 313).

Specifically, a message E1 is an event (transmission) that an instance A executes first and is an event (reception) that an instance X0 executes first. A message E0 is an event (transmission) that the instance X0 executes second and is an event (reception) that an instance B executes first. A message E2 is an event (transmission) that the instance X0 executes third and is an event (reception) that the instance A executes second.

In this manner, the group of scenarios for the design under verification are expressed by the hMSC information 210 depicted in FIG. 2 and a set of bMSC information (e.g., bMSC information 310) of the nodes N0 to N7 defined in the hMSC information 210.

The detailed description of hMSC is, for example, found by referring to Peled, Doron, “Specification and Verification using Message Sequence Chart”, Electronic Notes in Theoretical Computer Science 65, No. 72002.

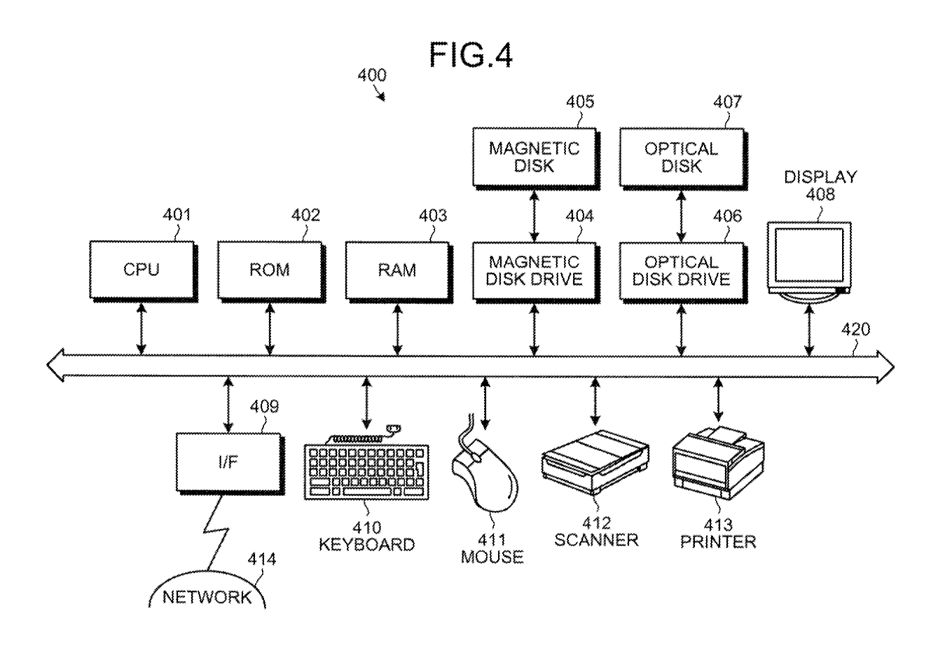

FIG. 4 is a block diagram of a hardware configuration of a verification apparatus according to the embodiment. As depicted in FIG. 4, the verification apparatus includes a central processing unit (CPU) 401, a read-only memory (ROM) 402, a random access memory (RAM) 403, a magnetic disk drive 404, a magnetic disk 405, an optical disk drive 406, an optical disk 407, a display 408, an interface (I/F) 409, a keyboard 410, a mouse 411, a scanner 412, and a printer 413, respectively connected by a bus 420.

The CPU 401 governs overall control of the verification apparatus. The ROM 402 stores therein programs such as a boot program. The RAM 403 is used as a work area of the CPU 401. The magnetic disk drive 404, under the control of the CPU 401, controls the reading and writing of data with respect to the magnetic disk 405. The magnetic disk 405 stores therein data written under control of the magnetic disk drive 404.

The optical disk drive 406, under the control of the CPU 401, controls the reading and writing of data with respect to the optical disk 407. The optical disk 407 stores therein data written under control of the optical disk drive 406, the data being read by a computer.

The display 408 displays, for example, data such as text, images, functional information, etc., in addition to a cursor, icons, and/or tool boxes. A cathode ray tube (CRT), a thin-film-transistor (TFT) liquid crystal display, a plasma display, etc., may be employed as the display 408.

The I/F 409 is connected to a network 414 such as a local area network (LAN), a wide area network (WAN), and the Internet through a communication line and is connected to other apparatuses through the network 414. The IF 409 administers an internal interface with the network 414 and controls the input and the output of data with respect to external apparatuses. For example, a modem or a LAN adaptor may be employed as the IF 409.

The keyboard 410 includes, for example, keys for inputting letters, numerals, and various instructions and performs the input of data. Alternatively, a touch-panel-type input pad or numeric keypad, etc. may be adopted. The mouse 411 is used to move the cursor, select a region, or move and change the size of windows. A track ball or a joy stick may be adopted provided each respectively has a function similar to a pointing device.

The scanner 412 optically reads an image and takes in the image data into the verification apparatus. The scanner 412 may have an optical character recognition (OCR) function as well. The printer 413 prints image data and text data. The printer 413 may be, for example, a laser printer or an ink jet printer.

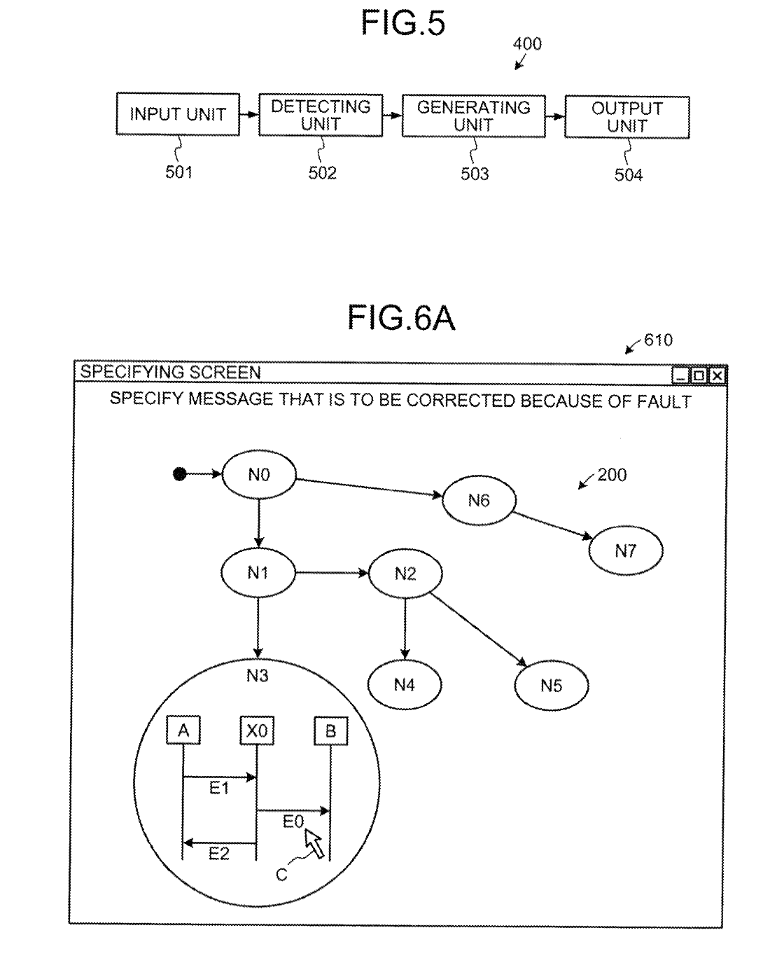

FIG. 5 is a diagram of a functional configuration of the verification apparatus. As depicted in FIG. 5, the verification apparatus 400 includes an input unit 501, a detecting unit 502, a generating unit 503, and an output unit 504. These functional units (input unit 501 to output unit 504), for example, are implemented when programs stored to a memory device such as the ROM 402, the RAM 403, the magnetic disk 405, and the optical disk 407 depicted in FIG. 4 are executed by the CPU 401 or by operation of the IF 409.

The input unit 501 has a function of receiving an input of a group of scenarios for verifying an operation of a design under verification. Specifically, for example, the input unit 501 receives the hMSC information 210 and the bMSC information 310 input by the user via the keyboard 410 or mouse 411 depicted in FIG. 4. The input scenarios are stored to a memory device such as the RAM 403, the magnetic disk 405, and the optical disk 407.

The input unit 501 has a further function of receiving specification of a faulty node representing a sequence in which a fault has occurred, the faulty node being specified from a structure expressing the group of scenarios for verifying an operation of the design under verification. Specifically, for example, the input unit 501 may receive specification of the faulty node via specifying screens 610 and 620 depicted in FIGS. 6A and 6B through user operation of the keyboard 410 or mouse 411 of FIG. 4.

FIGS. 6A and 6B are explanatory diagrams of examples of the specifying screens. In FIGS. 6A and 6B, the specifying screens 610 and 620 for specifying a faulty node are displayed on the display 408 (see FIG. 4).

On the specifying screen 610, the user moves a cursor C to click the message E0, which is to be corrected because of a fault. Hence, the user is able to specify the faulty node N3 from the structure 200. When the cursor C is moved to be superposed on any one of the nodes N0 to N7, the contents of the corresponding sequence represented by the node N0 to N7 are displayed in an enlarged view, for example.

On the specifying screen 620, the user enters into a box B1, the node name of the faulty node and further enters into a box B2, the message name of the event that is to be corrected because of the fault. Hence, the user is able to specify the faulty node N3 from the structure 200.

Although the faulty node may be specified on the specifying screens 610 and 620, this is not the only case. For example, the input unit 501 may receive input of fault information for identifying a faulty node. The specified faulty node is, for example, stored to a similar node table 700 depicted in FIG. 7.

In the following description, a group of nodes included in the structure are described as “group of nodes N1 to Nn”, and an arbitrary node among the group of nodes N1 to Nn is described as “node Ni” (i=0, 1, . . . , n). A faulty node specified from the structure is described as “faulty node TgN”, except when the faulty node is referred to by a specific denotation.

FIG. 7 is an explanatory diagram of an example of the memory contents of the similar node table. As depicted in FIG. 7, the similar node table 700 includes items of faulty node ID, first similar node ID, second similar node ID, and third similar node ID. Information is set for each of the items to store similar node information (e.g., similar node information 700-1) concerning each faulty node TgN as a record.

The faulty node ID is an identifier for identifying the faulty node TgN among the group of nodes N1 to Nn. The first similar node ID is an identifier for identifying a first similar node similar to the faulty node TgN. The second similar node ID is an identifier for identifying a second similar node similar to the faulty node TgN. The third similar node ID is an identifier for identifying a third similar node similar to the faulty node TgN.

The first, the second, and the third similar nodes are similar-nodes that are classified by similarity levels B1 to B3 according to similarity to the faulty node TgN. The magnitudes of the similarity levels B1 to B3 representing the levels of similarities between the first, the second, and the third similar nodes and the faulty node TgN are defined as “B1>B2>B3”, where a similarity level of a larger value indicates greater similarity to the faulty node TgN.

For example, when the faulty node N3 is specified, “N3” is entered into the faulty node ID item in the similar node table 700, and the similar node information 700-1 is stored as a new record. The similar node table 700 is realized by, for example, a memory device such as the RAM 403, the magnetic disk 405, and the optical disk 407.

In FIG. 5, the detecting unit 502 has a function of detecting a similar node similar to the faulty node TgN, from the structure expressing the group of scenarios for the design under verification. The similar node is node Ni representing a similar sequence similar to the sequence represented by the faulty node TgN. The similar sequence is, for example, equivalent to the node Ni that matches the sequence represented by the faulty node TgN in at least any one among an object (or instance), an event (or message), and the order of execution of events.

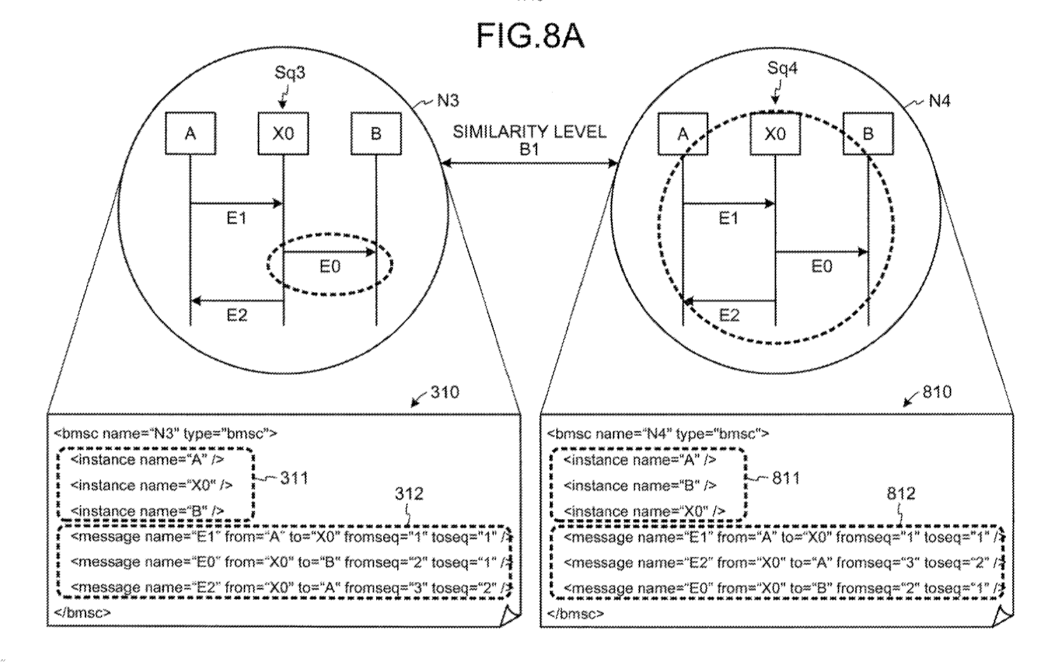

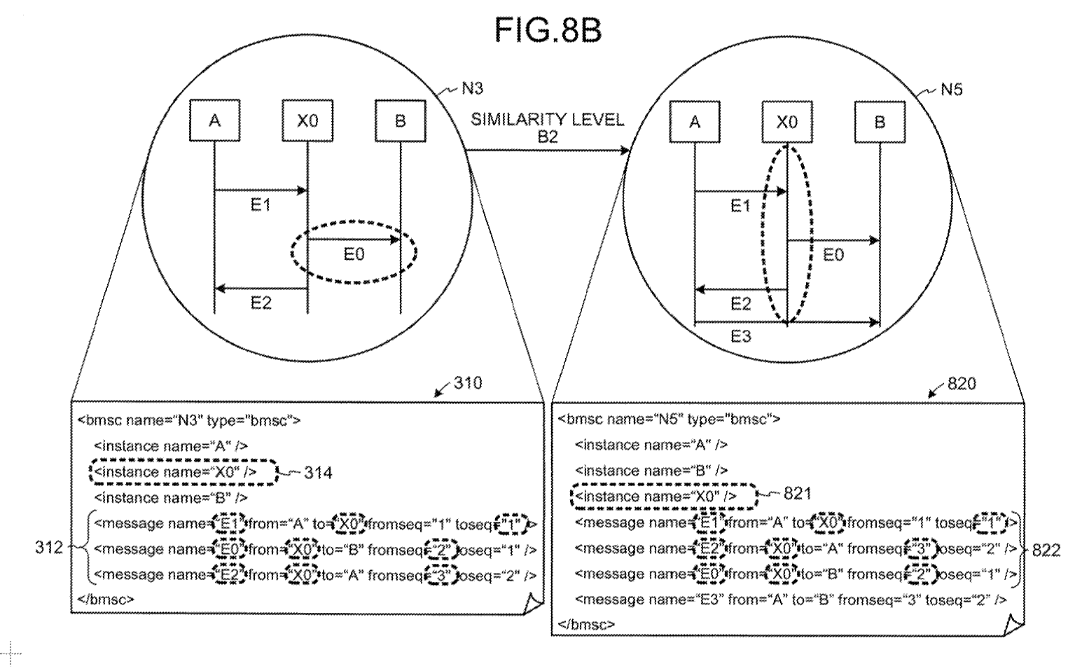

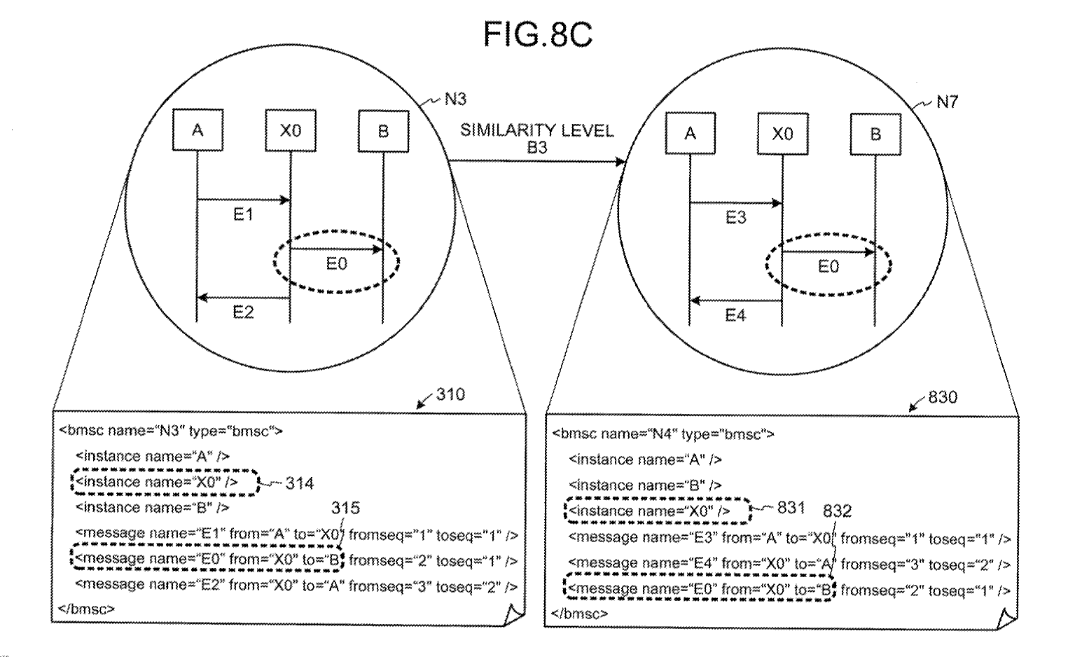

Similar nodes are classified into multiple types according to similarity levels indicative of similarity to the faulty node TgN. Specifically, for example, the detecting unit 502 may detect from the structure, three types of similar nodes including the first, the second, and the third similar nodes. Specific contents of a detecting process will be described later with reference to FIGS. 8A to 8C.

The generating unit 503 has a function of generating a scenario that includes sequences represented by a group of nodes on a path starting from a start node of the structure to a detected similar node. Specifically, for example, the generating unit 503 executes breadth first search from the start node of the structure to determine the depth di of each node Ni from the start node in the structure. The depth di is represented as the number of nodes included in the shortest path from the start node to the node Ni.

Subsequently, the generating unit 503 searches for a path from the similar node to the start node so that the depth di is determined to be small. The generating unit 503 then generates a string of sequences represented by a group of nodes Nq to Np given by reversely arranging the group of nodes Np to Nq included in a retrieved path, as a scenario for verifying a related fault.

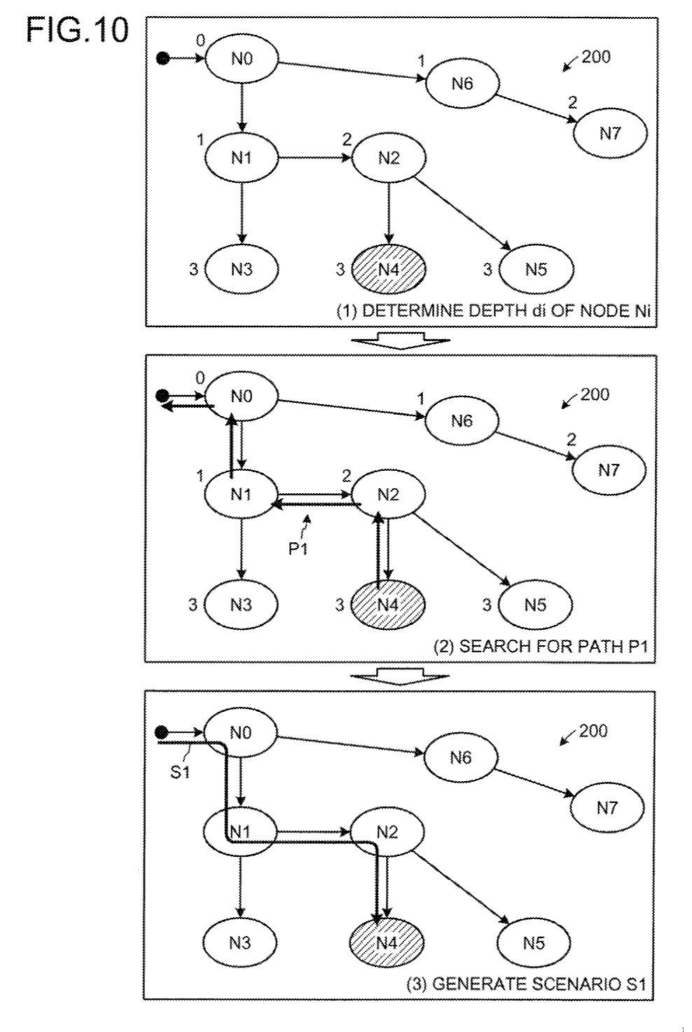

In this manner, a scenario is generated as a scenario for verifying a fault in the sequence represented by the similar node, i.e., a related fault related to a fault occurring at the faulty node TgN. Specific contents of a generating process will be described later with reference to FIG. 10.

The output unit 504 has a function of outputting the generated scenario. Specifically, for example, the output unit 504 may output the scenario written in XML. When outputting the scenario, the output unit 504 may output a scenario that is correlated with a similarity level indicative of the similarity to the faulty node TgN.

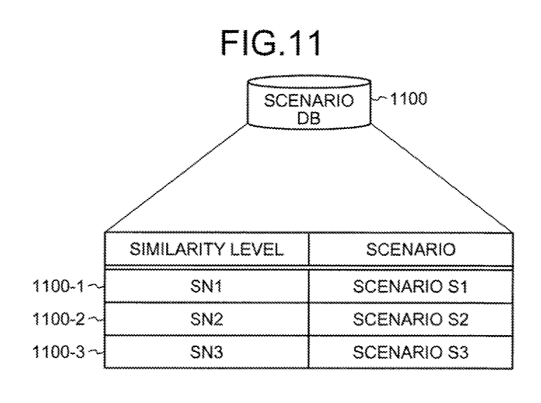

A specific example of the result of scenario output will be described later with reference to FIG. 11. Forms of output include, for example, display on the display 408, printout by the printer 413, and transmission to an external device through the IF 409. The result of scenario output may be stored to a memory device such as the RAM 403, the magnetic disk 405, and the optical disk 407.

FIGS. 8A to 8C are explanatory diagrams of examples of detection of a similar node. An example will be described where the detecting unit 502 detects the first to third similar nodes according to the similarity levels B1 to B3 indicating the similarity to the faulty node TgN (B1>B2>B3).

In this example, the faulty node TgN is the node N3, which is excluded from being subject to similar node detection. Each of the similarity levels B1 to B3, for example, is set according to a similarity condition for determining similarity to the faulty node TgN (see FIGS. 8A to 8C).

An example of detection of the first similar node having the similarity level B1 will first be described. The detecting unit 502 detects a node Ni representing the same sequence (MSC) as represented by the faulty node TgN, as the first similar node. Specifically, in FIG. 8A, for example, the detecting unit 502 detects from among the group of nodes N0 to N7, a node Ni having XML descriptions matching the XML descriptions 311 and 312 included in the bMSC information 310 of the faulty node N3.

The XML description 311 is description that defines a group of instances included in the sequence Sq3 represented by the faulty node N3. The XML description 312 is description that defines messages transmitted/received between the instances.

In this example, instances A, X0, and B and messages E1, E2, and E0 included in a sequence Sq4 represented by a node N4 match those included in the sequence Sq3 and all attribute values (from, to, fromseq, and toseq) of each of the messages E1, E2, and E0 also match. This means that bMSC information 810 of the node N4 has XML descriptions 811 and 812 matching the XML descriptions 311 and 312.

As a result, the detecting unit 502 detects the node N4 from among the group of nodes N0 to N7, as the first similar node. The first similar node detected for the faulty node N3 is, for example, set in the similar node information 700-1 in the similar node table 700 depicted in FIG. 7.

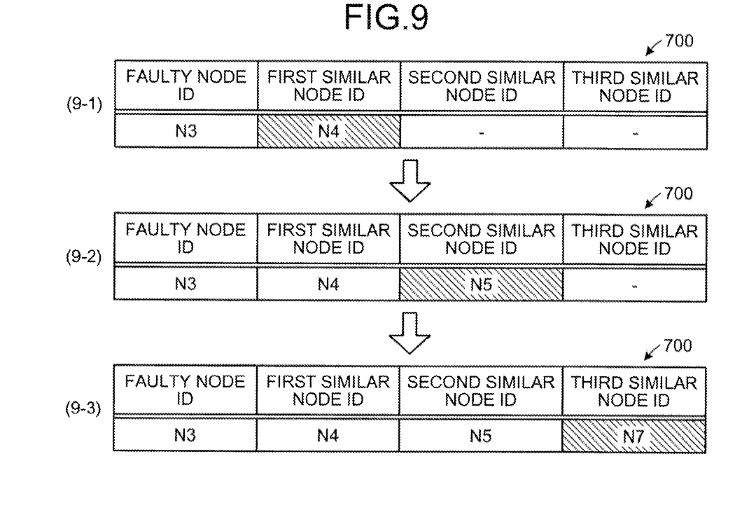

FIG. 9 is an explanatory diagram of examples of setting in the similar node table. As depicted in FIG. 9, as a result of detection of the node N4 as the first similar node, “N4” is entered in the first similar node ID item of the similar node information 700-1 in the similar node table 700 ((9-1) in FIG. 9).

An example of detection of the second similar node having the similarity level B2 will be described. In the following description, a message that is to be corrected because of a fault is described as “message TgM”, and an instance that is an executor of the message TgM is described as “instance TgI”. A message sequence for the instance TgI is described as “message sequence TgMS”. A message sequence represents the order of execution of a group of events executed by an instance.

The detecting unit 502 detects a node Ni that includes the same instance TgI as the instance TgI in the faulty node TgN. When a message sequence for the instance TgI in the node Ni is the same as the message sequence TgMS for the instance TgI in the faulty node TgN, the detecting unit 502 detects the node Ni as the second similar node.

For example, in FIG. 8B, the detecting unit 502 detects from among the group of nodes N0 to N7, the node Ni having an XML description matching an XML description 314 included in the bMSC information 310 of the faulty node N3. An XML description 821 is a description that defines the instance TgI that is the executor of the fault-causing message TgM. In this example, the description 821 included in bMSC information 820 of a node N5 matches the XML description 314.

Subsequently, the detecting unit 502 detects an XML description matching in the direction (from/to) and the order (fromseq/toseq) of a message having the instance TgI at “from” and “to”. In other words, the detecting unit 502 detects the node Ni having an XML description matching a description of portions encompassed by dotted lines in the XML description 312 of the faulty node N3. In this example, a description of portions encompassed by dotted lines in an XML description 822 of the node 5 matches the description of the portions encompassed by dotted lines in the XML description 312.

As a result, the detecting unit 502 detects from among the group of nodes N0 to N7, the node N5 as the second similar node. The second similar node detected for the faulty node N3 is, for example, set in the similar node information 700-1 in the similar node table 700. Specifically, in FIG. 9, as a result of detection of the node N5 as the second similar node, “N5” is entered in the second similar node ID item of the similar node information 700-1 ((9-2) in FIG. 9).

An example of detection of the third similar node with the similarity level B3 will be described. The detecting unit 502 detects a node Ni that includes the same instance TgI as the instance TgI that is the executor of the fault-causing message TgM. When a message of the instance TgI in the detected node Ni is the same as the message TgM of the instance TgI in the faulty node TgN, the detecting unit 502 detects the node Ni as the third similar node.

For example, in FIG. 8C, the detecting unit 502 detects, from among the group of nodes N0 to N7, the node Ni having an XML description matching the XML description 314 included in the bMSC information 310 of the faulty node N3. In this example, a description 831 included in bMSC information 830 of a node N7 matches the XML description 314.

Subsequently, the detecting unit 502 detects an XML description of the same message as the message TgM of the instance TgI (matching in message name, from, and to). In other words, the detecting unit 502 detects a node Ni having an XML description matching an XML description 315 of the faulty node N3. In this example, an XML description 832 of the node N7 matches the XML description 315.

As a result, the detecting unit 502 detects from among the group of nodes N0 to N7, the node N7 as the third similar node. The third similar node detected for the faulty node N3 is, for example, set in the similar node information 700-1 in the similar node table 700. Specifically, in FIG. 9, as a result of detection of the node N7 as the third similar node, “N7” is entered in the third similar node ID item of the similar node information 700-1 ((9-3) in FIG. 9).

A case of generating a scenario for verifying the occurrence of a fault at the similar node N4 will be described. FIG. 10 is an explanatory diagram of an example of scenario generating.

In FIG. 10, the generating unit 503 executes breadth first search from the start node N0 of the structure 200 to determine the depth di of each of the nodes N0 to N7 from the start node N0 in the structure 200 ((1) in FIG. 10). Subsequently, the generating unit 503 searches for a path P1 from the similar node N4 to the start node N0 so that the depth di is determined to be small ((2) in FIG. 10).

The generating unit 503 then generates a row of nodes (group of nodes N0, N1, N2, and N4) given by reversely arranging a group of nodes N4, N2, N1, and N0 included in the retrieved path P1, as a scenario S1 for verifying a similar fault. In other words, the generating unit 503 generates the scenario S1 for executing sequences represented by the nodes N0, N1, N2, and N4 in the order of “node N0→node N1→node N2→node N4”. The result of scenario generating is stored, for example, in a scenario database (DB) 1100 depicted in FIG. 11.

FIG. 11 is an explanatory diagram of an example of the memory contents of the scenario DB. As depicted in FIG. 11, a scenario DB 1100 includes items of similarity level and scenario. Information is set for each item to store scenario information 1100-1 to 1100-3 as records in the scenario DB.

The similarity level is an index value indicative of a level of similarity to the faulty node TgN. The scenario is scenario data for verifying a related fault described in XML. The scenario DB 1100 is realized by, for example, a memory area as such in the RAM 403, magnetic disk 405, and optical disk 407.

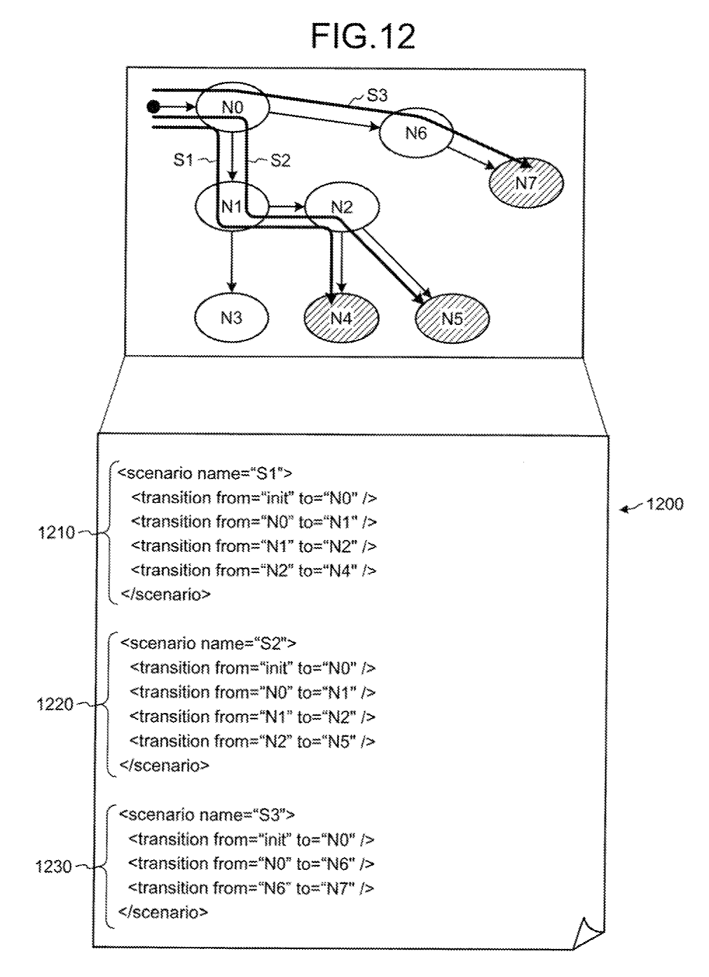

FIG. 12 is an explanatory diagram of an example of a scenario. FIG. 12 depicts scenario information 1200 for verifying a related fault related to a fault occurring at the faulty node N3. Specifically, in the scenario information 1200, XML descriptions 1210, 1220, and 1230 representing scenarios S1, S2, and S3, respectively, are arranged in descending order of similarity level to the faulty node N3, the order of which is the similarity levels B1, B2, and B3.

The XML description 1210 represents the scenario S1 for executing the sequences represented by the nodes N0, N1, N2, and N4 in the order of “node N0→node N1÷node N2→node N4”. The XML description 1220 represents a scenario S2 for executing sequences represented by nodes N0, N1, N2, and N5 in the order of “node N0→node N1-÷node N2→node N5”. The XML description 1230 represents a scenario S3 for executing sequences represented by nodes N0, N6, and N7 in the order of “node N0→node N6→node N7”.

According to the scenario information 1200, a scenario including a similar sequence having a high level of similarity to a sequence in which a fault occurred (scenario S1) is executed preferentially at verification, thereby improving the possibility of finding a related fault at an early stage, verification quality, and shortening the time consumed for verification work.

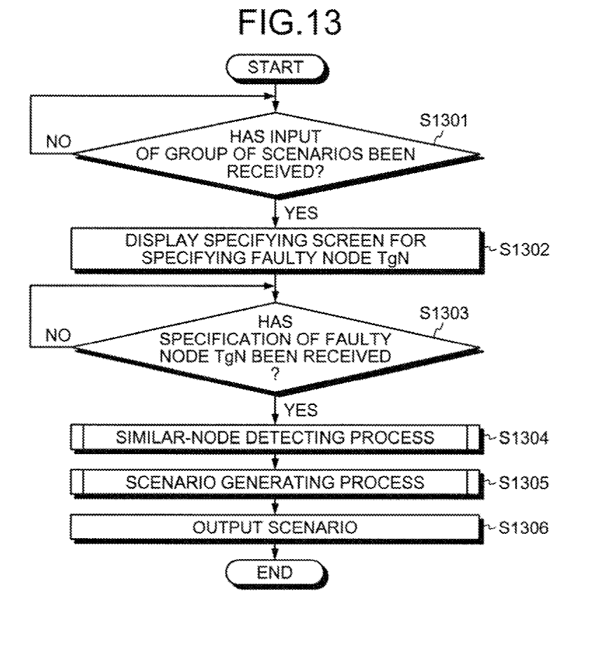

FIG. 13 is a flowchart of an example of a verification procedure by the verification apparatus. In the flowchart of FIG. 13, the input unit 501 determines whether input of a group of scenarios for verifying an operation of a design under verification has been received (step S1301).

Input of the group of scenarios is waited for (step S1310: NO). When the group of scenarios has been input (step S1301: YES), the output unit 504 displays on the display 408, the specifying screen 610 for specifying the faulty node TgN (step S1302). The input unit 501 then determines whether specification of the faulty node TgN has been received (step S1303).

Specification of the faulty node TgN is waited for (step S1303: NO). When the faulty node TgN has been specified (step S1303: YES), the detecting unit 502 executes a similar-node detecting process of detecting a similar node similar to the faulty node TgN (step S1304). The specified faulty node TgN is stored in the similar node table 700 of FIG. 7.

The generating unit 503 then executes a scenario generating process of generating a scenario for verifying the occurrence of a related fault related to a fault occurring at the design under verification (step S1305). Finally, the output unit 504 outputs the generated scenarios to the faulty node TgN, in descending order of similarity level (step S1306), and a series of operations of the flowchart comes to an end.

In this manner, a scenario for verifying a fault in a sequence represented by a similar node to the faulty node TgN, i.e., a related fault related to a fault occurring at the faulty node TgN is generated automatically.

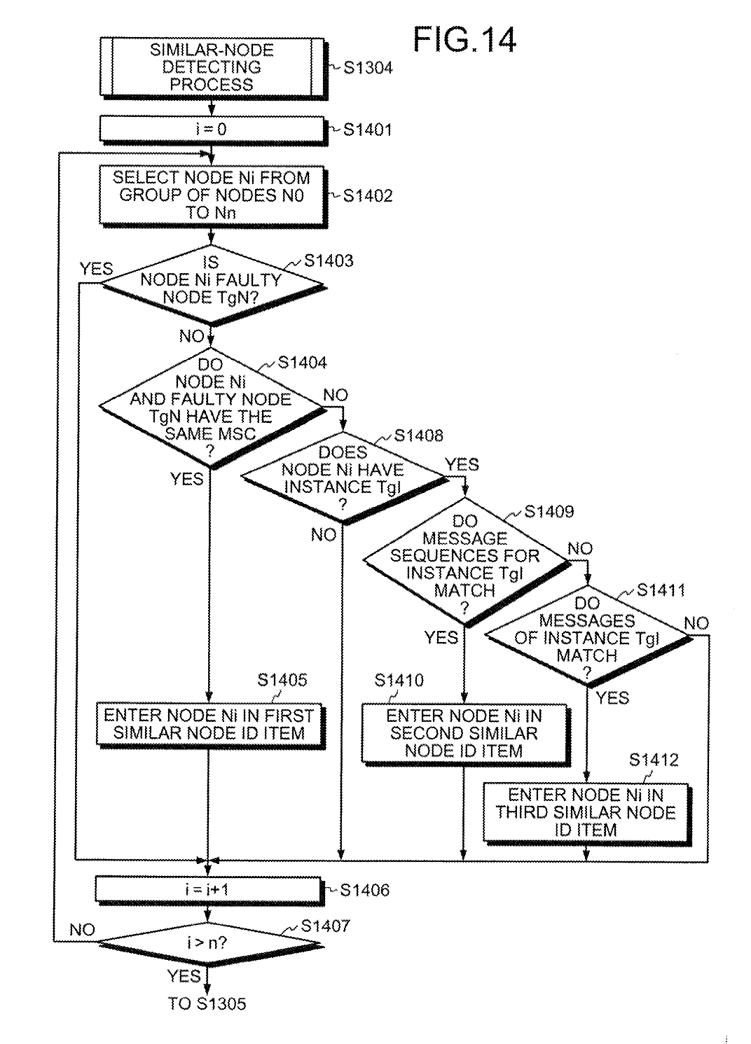

FIG. 14 is a flowchart of an example of a the similar-node detecting process.

As depicted in FIG. 14, the detecting unit 502 initializes the node Ni to “i=0” (step S1401), and selects a node Ni from among a group of nodes N0 to Nn included in a structure expressing a group of scenarios for the design under verification (step S1402). The detecting unit 502 then determines whether the node Ni is the faulty node TgN (step S1403). The faulty node TgN is the faulty node TgN specified at step S1302 of FIG. 13.

If the node Ni is not the faulty node TgN (step S1403: NO), the detecting unit 502 determines whether the node Ni and the faulty node TgN have the same MSC (step S1404). If the nodes have the same MSC (step S1404: YES), the detecting unit 502 enters the node Ni in the first similar node ID item for the faulty node TgN in the similar node table 700 (step S1405).

The detecting unit 502 then increments i by 1 (step S1406), and determines whether “i>n” is satisfied (step S1407). If “in” is satisfied (step S1407: NO), the procedure returns to step S1402. If “i>n” is satisfied (step S1407: YES), the procedure proceeds to step S1305 of FIG. 13.

If the node Ni is the faulty node TgN at step S1403 (step S1403: YES), the procedure proceeds to step S1406.

If the node Ni does not have the same MSC as that of the faulty node TgN at step S1404 (step S1404: NO), the detecting unit 502 determines whether the node Ni has the instance TgI (step S1408). The instance TgI is the instance that is the executor of a fault-causing event (message).

If the node Ni does not have the instance TgI (step S1408: NO), the procedure proceeds to step S1406. If the node Ni has the instance TgI (step S1408: YES), the detecting unit 502 determines whether a message sequence for the instance TgI in the node Ni matches the message sequence TgMS for the instance TgI in the faulty node TgN (step S1409).

If the message sequences match (step S1409: YES), the detecting unit 502 enters the node Ni in the second similar node ID item for the faulty node TgN in the similar node table 700 (step S1410).

If the message sequences do not match (step S1409: NO), the detecting unit 502 determines whether a message of the instance TgI in the node Ni matches the message TgM of the instance TgI in the faulty node TgN (step S1411).

If the messages match (step S1411: YES), the detecting unit 502 enters the node Ni in the third similar node ID item for the faulty node TgN in the similar node table 700 (step S1412), after which the procedure proceeds to step S1406. If the messages do not match (step S1411: NO), the procedure proceeds to step S1406.

In this manner, three types of similar nodes including the first, the second, and the third similar nodes can be detected according to the similarity levels B1, B2, and B3 indicative of similarity to the faulty node TgN.

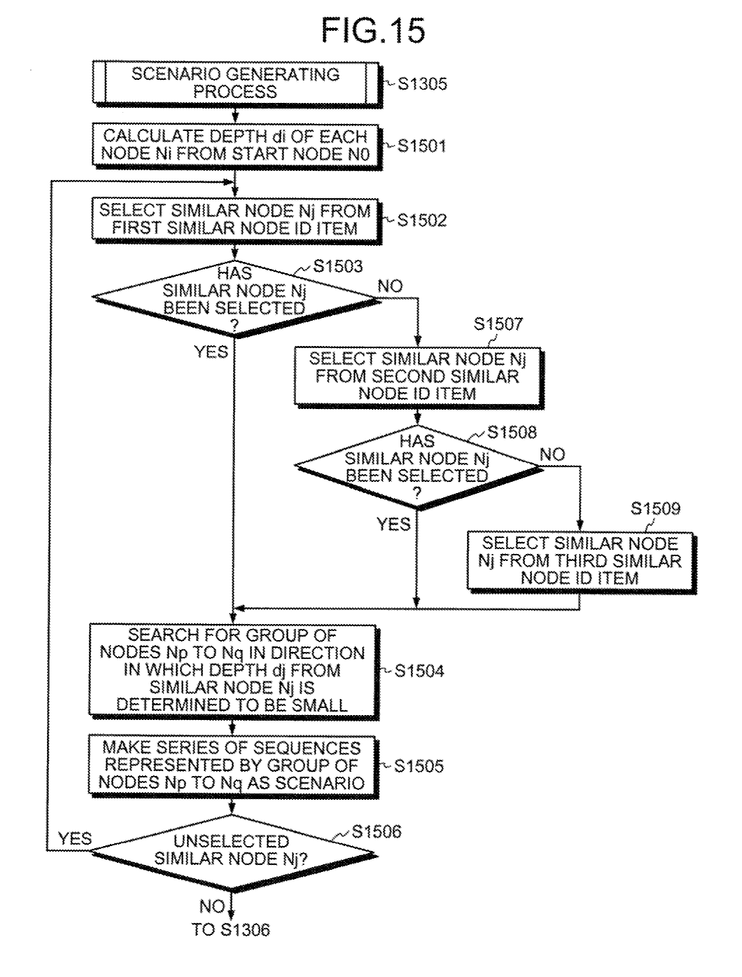

FIG. 15 is a flowchart of an example of the scenario generating process.

As depicted in the flowchart of FIG. 15, the generating unit 503 calculates the depth di of each node Ni from the start node N0 in a structure expressing a group of scenarios for a design under verification (step S1501). The generating unit 503 then selects a similar node Nj (j=0, 1, . . . , n), from the first similar node ID item for the faulty node TgN in the similar node table 700 (step S1502).

If a similar node Nj has been selected from the first similar node ID item (step S1503: YES), the generating unit 503 searches for a group of nodes Np to Nq in a direction in which the depth dj from the similar node Nj is determined to be small in the structure (step S1504).

The generating unit 503 then generates, as a scenario, a string of sequences represented by the group of nodes Nq to Np given by reversely arranging the retrieved group of nodes Np to Nq (step S1505). The generated scenario is stored to the scenario DB 1100 depicted in FIG. 11. In this scenario generation, the similarity level of a scenario including the first similar node is “B1”, the similarity level of a scenario including the second similar node is “B2”, and the similarity level of a scenario including the third similar node is “B3”.

Subsequently, the generating unit 503 determines whether a similar node Nj not selected from the similar node table 700 is present (step S1506). If an unselected similar node is present (step S1506: YES), the procedure returns to step S1502.

If a similar node Nj has not been selected from the first similar node ID item at step S1503 (step S1503: NO), the generating unit 503 selects a similar node Nj from the second similar node ID item for the faulty node TgN in the similar node table 700 (step S1507).

If a similar node Nj has been selected from the second similar node ID item (step S1508: YES), the procedure proceeds to step S1504. If a similar node Nj has not been selected from the second similar node ID item (step S1508: NO), the generating unit 503 selects a similar node Nj from the third similar node ID item for the faulty node TgN in the similar node table 700 (step S1509), after which the procedure proceeds to step S1504.

If an unselected similar node Nj is not present at step S1506 (step S1506: NO), the procedure proceeds to step S1306 of FIG. 13.

In this manner, scenarios including sequences represented by the first, the second, and the third similar nodes can be generated in descending order of similarity level with respect to the faulty node TgN, the order of which is the similarity levels B1, B2, and B3.

As described above, the present embodiment enables automatic generation of a scenario that includes sequences represented by a group of nodes on a path starting from the start node N0 to a similar node similar to the faulty node TgN in a structure expressing a group of scenarios for a design under verification. This allows automatic generation of a scenario for verifying a fault in a sequence represented by the similar node, i.e., a related fault related to a fault occurring at the faulty node TgN.

The present embodiment enables the detection of a node, as the first similar node, representing the same sequence as represented by the faulty node. The present embodiment also enables detection of a node Ni, as the second similar node, that includes the instance TgI having the same message sequence as the message sequence TgMS of the instance TgI in the faulty node TgN. The present embodiment further enables the detection of, as the third similar node, the node N3, which includes the same instance TgI as the instance TgI in the faulty node TgN. This allows detection of a plurality of types (three) of similar nodes having different levels of similarity (e.g., similarity levels B1 to B3) to the faulty node TgN.

The present embodiment enables the generation of a scenario that includes sequences represented by the first, the second, and the third similar nodes in descending order of similarity level with respect to the faulty node TgN, the order of which is the similarity levels B1, B2, and B3. As a result, a scenario including a similar sequence with a high level of similarity to a sequence in which a fault is occurring is executed preferentially. This improves the possibility of finding a related fault at an early stage, thereby improving verification quality and shortening the time consumed for verification work. A verifier has no need of determining the order of execution of a group of scenarios, thereby eliminating an erroneous determination by the verifier and reducing the burden on the verifier.

The verification method described in the present embodiment may be implemented by executing a prepared program on a computer such as a personal computer and a workstation. The program is stored on a computer-readable non-transitory medium such as a hard disk, a flexible disk, a CD-ROM, an MO, and a DVD, read out from the recording medium, and executed by the computer. The program may be a transmission medium that can be distributed through a network such as the Internet.

The embodiment offers an effect of improving the comprehensiveness of verification related to software or hardware.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A computer-readable, non-transitory medium storing therein a verification program causing a computer to execute:
detecting from a structure expressing a group of scenarios for verifying an operation of a design under verification and by hierarchizing sequences for realizing the operation as nodes, a similar node similar to a faulty node representing a sequence in which a fault has occurred;
generating a string of sequences represented by a group of nodes on a path starting from a start node of the structure to the detected similar node; and
outputting the generated string of sequences.

2. The computer-readable, non-transitory according to claim 1, wherein
the detecting includes detecting as the similar node, a node representing a sequence identical to the sequence represented by the faulty node.

3. The computer-readable, non-transitory according to claim 1, wherein
the detecting includes detecting, as the similar node, a node that includes an element identical to an element that is among a group of elements that are executors of the sequence and is an executor of a process in which the fault occurred, the node further including an element that executes a sequence in an order of execution identical to an order of execution of the sequence executed by the element that is the executor of the process in which the fault occurred.

4. The computer-readable, non-transitory according to claim 1, wherein
the detecting includes detecting, as the similar node, a node that includes an element identical to an element that among a group of elements that execute the sequence and is an executor of a process in which the fault occurred.

5. The computer-readable, non-transitory according to claim 2, wherein
the generating includes, when a plurality of similar nodes similar to the faulty node are detected, generating a string of sequences represented by a group of nodes on a path starting from the start node to the similar nodes, in descending order of level of similarity of the similar nodes with the faulty node.

6. The computer-readable, non-transitory according to claim 3, wherein
the generating includes, when a plurality of similar nodes similar to the faulty node are detected, generating a string of sequences represented by a group of nodes on a path starting from the start node to the similar nodes, in descending order of level of similarity of the similar nodes with the faulty node.

7. The computer-readable, non-transitory according to claim 4, wherein
the generating includes, when a plurality of similar nodes similar to the faulty node are detected, generating a string of sequences represented by a group of nodes on a path starting from the start node to the similar nodes, in descending order of level of similarity of the similar nodes with the faulty node.

8. A verification apparatus comprising:
a detecting unit that, from a structure expressing a group of scenarios for verifying an operation of a design under verification and by hierarchizing sequences for realizing the operation as nodes, detects a similar node similar to a faulty node representing a sequence in which a fault has occurred;
a generating unit that generates a string of sequences represented by a group of nodes on a path starting from a start node of the structure to the detected similar node; and
an outputting unit that outputs the generated string of sequences.

9. A verification apparatus comprising:
a processor configured to execute a procedure, the procedure comprising:
detecting from a structure expressing a group of scenarios for verifying an operation of a design under verification and by hierarchizing sequences for realizing the operation as nodes, a similar node similar to a faulty node representing a sequence in which a fault has occurred;
generating a string of sequences represented by a group of nodes on a path starting from a start node of the structure to the detected similar node; and
outputting the generated string of sequences.

10. A verification method comprising:
detecting from a structure expressing a group of scenarios for verifying an operation of a design under verification and by hierarchizing sequences for realizing the operation as nodes, a similar node similar to a faulty node representing a sequence in which a fault has occurred;
generating a string of sequences represented by a group of nodes on a path starting from a start node of the structure to the detected similar node; and
outputting the generated string of sequences.
